(19) United States
(12) Patent Application Publication
(10) Pub. No.: US 2021/0364873 A1
(43) Pub. Date: Nov. 25, 2021

(54) METHOD FOR FABRICATING COLOR FILTER ARRAY SUBSTRATE AND COLOR FILTER ARRAY SUBSTRATE

(71) Applicant: TCL China Star Optoelectronics Technology Co., Ltd, Shenzhen (CN)

(72) Inventor: Chengzhong YU, Shenzhen (CN)

(21) Appl. No.: 16/616,455

(22) PCT Filed: Oct. 21, 2019
(86) PCT No.: PCT/CN2019/112229

§ 371 Date: Nov. 23, 2019

(30) Foreign Application Priority Data
Jul. 16, 2019 (CN) 201910640625.7

(51) Int. Cl. G02F 1/1362; G02F 1/1368

(52) U.S. Cl. CPC G02F 1/136222; G02F 1/1368

(57) ABSTRACT

A method for fabricating a color filter array substrate and a color filter array substrate are provided. The method includes sequentially forming a thin-film-transistor (TFT) structural layer, a passivation layer, a color resist layer, a planarization layer over the substrate. An opening structure is formed over the planarization layer, the color resist layer, and the passivation layer, and the opening structure simultaneously penetrates the planarization layer, the color resist layer, and the passivation layer, and exposes the source/drain metal layer. A transparent conductive layer is formed over the planarization layer to cover the opening structure and electrically connect the source/drain metal layer.

### FIELD OF INVENTION

The present invention relates to a display technology, and more particularly to a method for fabricating a color filter array substrate and a color filter array substrate.

### BACKGROUND

Color-filter on Array (COA) technology is an integrated technology that directly fabricates a color filter layer on an array substrate. It can effectively solve the problem of light leakage caused by the misalignment during the boxing process of the liquid crystal display device, and can significantly improve the display aperture ratio. In the production process, the COA technology requires to form an opening in the color resist layer so that the uppermost pixel electrode can be electrically connected to the metal layer of thin film transistor array structure layer under the color resist.

In the prior art, it is generally required to form an opening by an exposure process when preparing a color resist layer. However, considering that there is a deviation of ±3-4 in the color resist layer during the exposure process while aligning the photomask with the mark on the substrate, so it is required to increase a width of the metal layer under of the opening region. In addition, in the latter process of the color resist layer, while forming an opening in the planarization layer, the opening width CD2 of the color resist layer is required to be 6-8 μm greater than the opening width CD3 of the planarization layer due to the deviation of the alignment accuracy between the photomask and the mark over the substrate. is, as shown in FIG. 1. There are two problems in this way. First, enlargement of the opening width of the color resist layer further increases the width of the metal CD1, thereby reducing the aperture ratio of the product; secondly, since the aperture of the color resist layer opening cannot be fabricated in a too small size, thereby failing to meet the requirements of high resolution of small size products.

### SUMMARY

The present application a method for fabricating a color filter array substrate and a color filter array substrate to solve the technical problems of low aperture ratio of the present method for fabricating the color filter array substrate.

An embodiment of the present application provides a method for fabricating a color filter array substrate, comprising the following steps:

providing a substrate;

forming a thin-film-transistor (TFT) structural layer over the substrate, wherein the TFT structural layer comprises a source/drain metal layer;

forming a passivation layer over the TFT structural layer;

forming a color resist layer over the passivation layer;

forming a planarization layer over the color resist layer;

forming an opening structure over the planarization layer, the color resist layer, and the passivation layer, wherein the opening structure simultaneously penetrates the planarization layer, the color resist layer, and the passivation layer, and exposes the source/drain metal layer;

forming a transparent conductive layer over the planarization layer, wherein the transparent conductive layer covers the opening structure and electrically connects the source/drain metal layer;

wherein forming the opening structure over the planarization layer, the color resist layer, and the passivation layer comprising the following steps:

forming a first opening in the planarization layer;

forming a second opening in the color resist layer and the passivation layer at an area corresponding to the first opening, wherein the second opening penetrates the color resist layer and the passivation layer to expose the source/drain metal layer, and the first opening and the second opening form the opening structure; and

the passivation layer is an inorganic material layer.

In the method for fabricating a color filter array substrate of the present application, the first opening is formed by a photolithography process, and the second opening is formed by a dry etching process.

In the method for fabricating a color filter array substrate of the present application, the first opening and the second opening are formed by the same photomask.

In the method for fabricating a color filter array substrate of the present application, the opening hole structure is formed by a dry etching process in one time during the step of forming the opening structure over the planarization layer, the color resist layer, and the passivation layer.

In the method for fabricating a color filter array substrate of the present application, wherein forming the thin-film-transistor (TFT) structural layer over the substrate comprising the following steps:

forming a gate metal layer over the substrate;

forming a gate insulating layer over the gate metal layer;

forming an active layer over the gate insulating layer;

forming an ohmic contact layer over the active layer; and

forming the source/drain metal layer over the ohmic contact layer.

An embodiment of the present application provides a method for fabricating a color filter array substrate, comprising the following steps:

providing a substrate;

forming a thin-film-transistor (TFT) structural layer over the substrate, wherein the TFT structural layer comprises a source/drain metal layer;

forming a passivation layer over the TFT structural layer;

forming a color resist layer over the passivation layer;

forming a planarization layer over the color resist layer;

forming an opening structure over the planarization layer, the color resist layer, and the passivation layer, wherein the opening structure simultaneously penetrates the planarization layer, the color resist layer, and the passivation layer, and exposes the source/drain metal layer;

forming a transparent conductive layer over the planarization layer, wherein the transparent conductive layer covers the opening structure and electrically connects the source/drain metal layer.

In the method for fabricating a color filter array substrate of the present application, wherein forming the opening structure over the planarization layer, the color resist layer, and the passivation layer comprising the following steps:

forming a first opening in the planarization layer; and

forming a second opening in the color resist layer and the passivation layer at an area corresponding to the first opening, wherein the second opening penetrates the color resist layer and the passivation layer to expose the source/drain metal layer, and the first opening and the second opening form the opening structure.

In the method for fabricating a color filter array substrate of the present application, the first opening is formed by a photolithography process, and the second opening is formed by a dry etching process.

In the method for fabricating a color filter array substrate of the present application, the first opening and the second opening are formed by the same photomask.

In the method for fabricating a color filter array substrate of the present application, the opening hole structure is formed by a dry etching process in one time during the step of forming the opening structure over the planarization layer, the color resist layer, and the passivation layer.

In the method for fabricating a color filter array substrate of the present application, the passivation layer is an inorganic material layer.

In the method for fabricating a color filter array substrate of the present application, forming the thin-film-transistor (TFT) structural layer over the substrate comprising the following steps:

forming a gate metal layer over the substrate;

forming a gate insulating layer over the gate metal layer;

forming an active layer over the gate insulating layer;

forming an ohmic contact layer over the active layer; and

forming the source/drain metal layer over the ohmic contact layer.

The present application future provides a color filter array substrate, comprising:

a substrate;

a thin-film-transistor (TFT) structural layer disposed over the substrate, wherein the TFT structural layer comprises a source/drain metal layer;

a passivation layer disposed over the TFT structural layer;

a color resist layer disposed over the passivation layer;

a planarization layer disposed over the color resist layer;

an opening structure disposed over the planarization layer, the color resist layer, and the passivation layer, and exposes the source/drain metal layer; and

a transparent conductive layer disposed over the planarization layer, wherein the transparent conductive layer covers the opening structure and electrically connects the source/drain metal layer.

In the color filter array substrate of the present application, the first opening is disposed over the planarization layer, and a second opening is disposed over the color resist layer and the passivation layer, and the first opening and the second opening form the opening structure; and

the second opening comprises an upper portion and a lower portion, a sidewall of the upper potion is formed by the color resist layer, and a sidewall of the lower portion is formed by the passivation layer, wherein a sidewall of the first opening is formed by the planarization layer.

In the color filter array substrate of the present application, the first opening is formed by a photolithography process, and the second opening is formed by a dry etching process.

In the color filter array substrate of the present application, the passivation layer is an inorganic material layer.

In the color filter array substrate of the present application, the TFT structural structure further comprises a gate meal layer, a gate insulating layer, an active layer, an ohmic contact layer, and the source/drain metal layer.

Compared with the conventional method for fabrication a color filter array substrate and a conventional color filter array substrate, the method for preparing the color film array substrate of the present application and the color film array substrate do not form an opening than during the process of the color resist layer, but form an opening after formation of the planarization layer, thereby forming an opening structure through the planarization layer, the color resist layer, and the passivation layer. This arrangement avoids the requirement of the opening of the color resist layer and reduces the development difficulty of the color resist layer; Secondly, the alignment of the photomask and the substrate mark during the process of the color resist layer is avoided, and the deviation due to insufficient precision is avoided; the third is to improve the aperture ratio of the product; and the preparation of the existing color film array substrate of the technical problem of the lower aperture ratio is solved.

### BRIEF DESCRIPTION OF DRAWINGS

To detailly explain the technical schemes of the embodiments or existing techniques, drawings that are used to illustrate the embodiments or existing techniques are provided. Apparently, the illustrated embodiments are just a part of those of the present disclosure. It is easy for any person having ordinary skill in the art to obtain other drawings without labor for inventiveness.

FIG. 1 is a schematic structural view of a portion of a conventional color film array substrate;

FIG. 2 is a schematic flowchart of a method for forming a color filter array substrate according to an embodiment of the present application;

FIG. 3 is another schematic flowchart of a method for forming a color filter array substrate according to an embodiment of the present application;

FIG. 4 is a schematic flowchart of the step S2 in FIG. 2;

FIG. 5 is a schematic flowchart of the step S6 in FIG. 2;

FIG. 6 is a schematic structural view of a color filter array substrate according to an embodiment of the present application; and

FIG. 7 is a schematic structural view showing an opening structure of a color filter array substrate according to an embodiment of the present application.

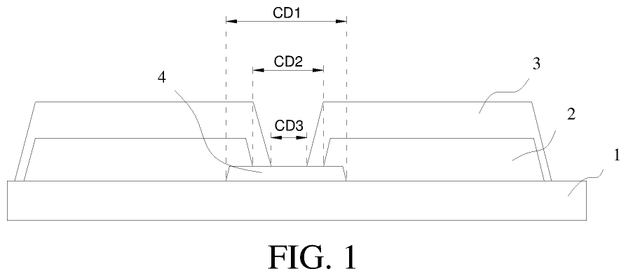

### DETAILED DESCRIPTION

Please refer to the drawings in the drawings, in which the same reference numerals represent the same components. The following description is based on the specific embodiments of the present invention as illustrated, and should not be construed as limiting the specific embodiments that are not described herein.

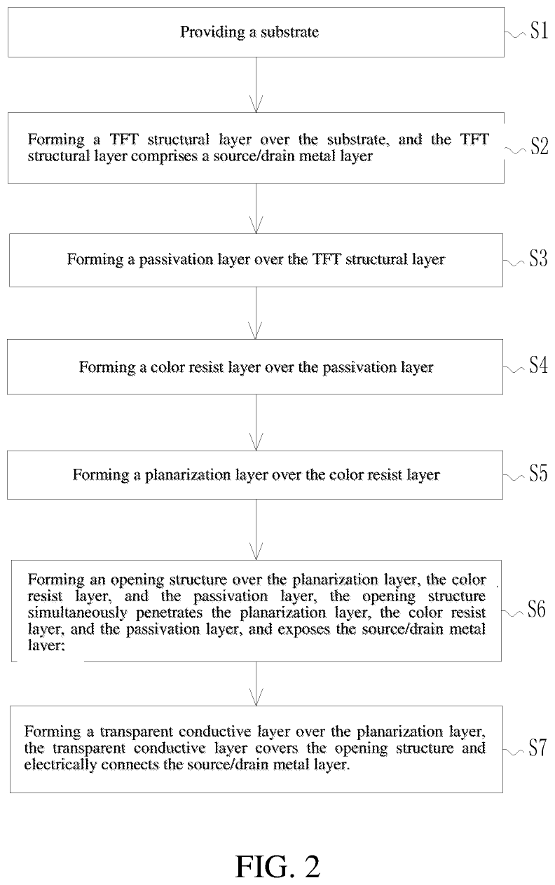

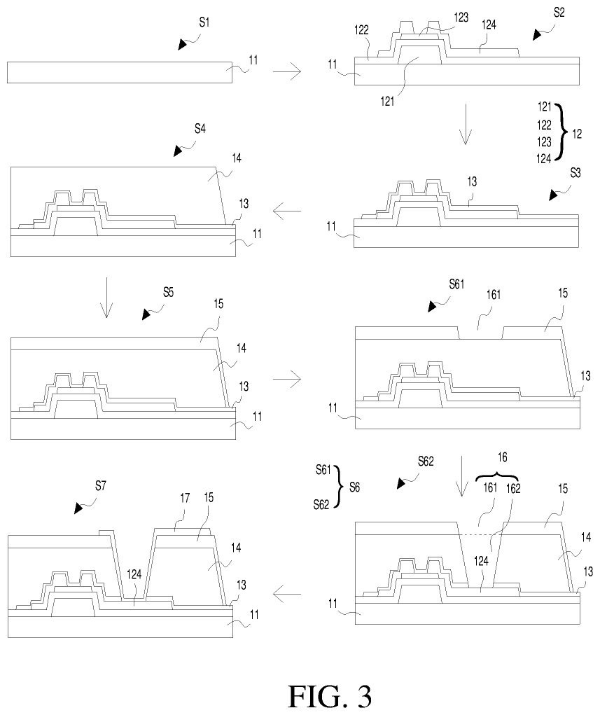

Referring to FIG. 2 and FIG. 3, FIG. 2 is a schematic flowchart of a method for forming a color filter array substrate according to an embodiment of the present application, and FIG. 3 is another schematic flowchart of a method for forming a color filter array substrate according to an embodiment of the present application.

The present application provides a method for fabricating a color filter array substrate, comprising the following steps:

S1: providing a substrate;

S2: forming a thin-film-transistor (TFT) structural layer over the substrate, wherein the TFT structural layer comprises a source/drain metal layer;

S3: forming a passivation layer over the TFT structural layer;

S4: forming a color resist layer over the passivation layer;

S5: forming a planarization layer over the color resist layer; and

S6: forming an opening structure over the planarization layer, the color resist layer, and the passivation layer, wherein the opening structure simultaneously penetrates the planarization layer, the color resist layer, and the passivation layer, and exposes the source/drain metal layer;

S7: forming a transparent conductive layer over the planarization layer, wherein the transparent conductive layer covers the opening structure and electrically connects the source/drain metal layer.

In the method for forming the color filter array substrate 100 of the embodiment of the present application, the opening is not formed during the process of the color resist layer (step S4), and is formed after formation of the planarization layer (step S5) to penetrate the planarization layer, the color resist layer and the protective layer so that an opening structure is formed.

Compared with the conventional technology, this arrangement firstly avoids the requirement of forming an opening in the color resist layer and reduces the difficulty for developing the color resist layer, and secondly avoids alignment between the mask and substrate identification mark during the color resist layer process to prevent deviation caused by insufficient precision, and thirdly increases the aperture ratio of the product.

In addition, in the conventional technology, since an opening is first formed in the color resist layer, and then the planarization layer fills the opening of the color resist layer, so that a thickness of the planarization film at the opening is thicker than other regions and more light is required for decomposition. Therefore, during the forming process, more exposure time is required in the case of a fixed exposure, and the tact time of production is increased, thereby limiting the increase in productivity.

The method for forming the color filter array substrate of the embodiment of the present application does not form an opening during the process of the color resist layer (step S4), and the opening is formed after formation of the planarization layer (step S5) to penetrate the planarization layer, the color resist layer, and the passivation layer and forms an opening structure. Since the color resist layer is not formed with an opening, the thickness of the planarization layer of the original opening area is not thicker than other areas, so that the exposure time performed to the planarization layer can be reduced, thereby increasing production capacity and reducing the production cost of the product.

The method of forming a color filter array substrate of the embodiment of the present application will be described in the following in greater detail.

Step S1: providing a substrate 11. Optionally, the substrate 11 is a rigid substrate such as a glass substrate. Optionally, the substrate 11 is a flexible substrate such as a polyimide substrate. Then, the process proceeds to step S2.

Step S2: forming a thin film transistor array structural layer 12 on the substrate 11.

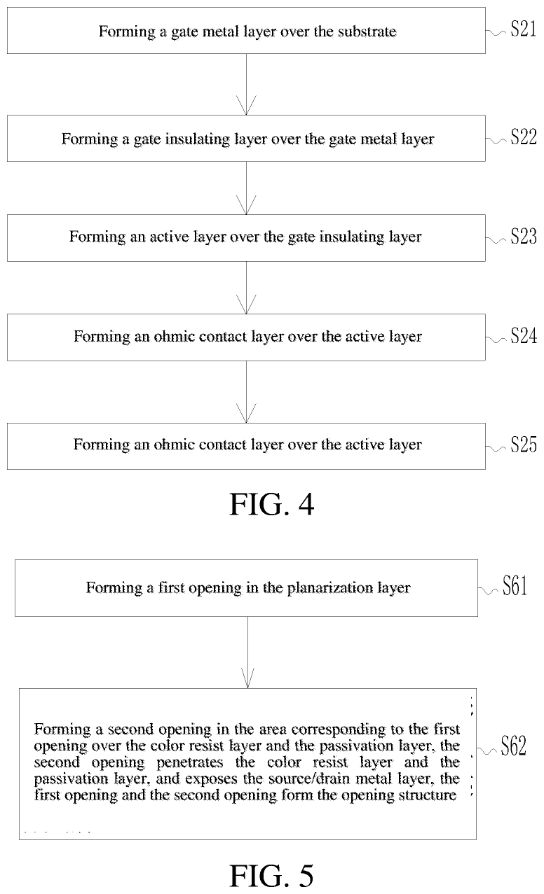

Specifically, referring to FIG. 4, step S2 comprises the following steps:

Step S21: forming a gate metal layer 121 over the substrate 11;

Step S22: forming a gate insulating layer 122 over the gate metal layer 121;

Step S23: forming an active layer 123 over the gate insulating layer 122;

Step S24: forming an ohmic contact layer over the active layer 123 (not shown); and

Step S25: forming the source/drain metal layer 124 over the ohmic contact layer.

The thin film transistor array structural layer 12 comprises a plurality of thin film transistors and metal traces. The thin film transistor comprises a top gate thin film transistor and a bottom gate thin film transistor, and this embodiment of the present application is described by a bottom gate thin film transistor, but is not limited thereto. In addition, the thin film transistor array structure layer is a conventional technology and will not be described again. Then, the process proceeds to step S3.

Step S3: forming a passivation layer 13 over the thin film transistor array structural layer 12. The passivation layer 13 is used to protect the source/drain metal layer 124. Optionally, the passivation layer 13 is an inorganic material layer such as SiNx. The passivation layer is deposited on the thin film transistor by chemical vapor deposition and covers the entire substrate 11. The passivation layer 13 can be a multilayer structure formed by alternately laminating two different inorganic materials. Then, the process proceeds to step S4.

Step S4: forming a color resist layer 14 over the passivation layer 13. The patterned color resist layer 14 is formed over the passivation layer 13 by a photolithography process. The color resist layer 14 comprises a red color resist, a green color resist, and a blue color resist.

It should be noted that, after formation of the color resist layer 14, no opening will be formed in the opening region of the color resist layer 14, and the process directly proceeds to step S5.

Step S5: forming a planarization layer 15 over the color resist layer 14. The process in which the planarization layer 15 is formed may be a photolithography process, a coating process, an inkjet printing process, or the like. It suffices that the flat layer 15 can be formed. Then, the process proceeds to step S6.

Step S6: forming an opening structure 16 over the passivation layer 15, the color resist layer 14, and the passivation layer 13. The opening structure 16 simultaneously penetrates the passivation layer 15, the color resist layer 14, and the protective layer 13 to expose the source/drain metal layer 124.

Specifically, please refer to FIG. 5, Step S6 comprises the following steps:

Step S61: forming a first opening 161 in the planarization layer 15;

Step S62: forming a second opening 162 in the area corresponding to the first opening 161 over the color resist layer 14 and the passivation layer 13. The second opening 162 penetrates the color resist layer 14 and the passivation layer 13, and exposes the source/drain metal layer 124. The first opening 161 and the second opening 162 form the opening structure 16.

In step S61, the planarization layer 15 is a photoresist. A preliminary structure of the planarization layer is formed by using coating and prebaking of photoresist in a photolithography process, and an open region of the preliminary structure is then exposed through a mask, and a first opening. 161 is then formed after development. The photolithography process is also called photo engraving process (PEP).

In step S62, after the first opening 161 is formed, a dry etching process is performed on the regions of the color resist layer 14 and the passivation layer 13 corresponding to the first opening 161 to form the second opening 162 until the second the opening 162 exposes the source/drain metal layer 124.

Herein, since there is no opening formed in the color resist layer 14 in advance, the film thickness of the planarization layer 15 in the original opening region is not thicker than other regions, so that the exposure time of the planarization layer 15 process can be reduced, thereby increasing the productivity and reducing production costs of the product.

In addition, the opening is formed in the color resist layer 14 by dry etching, which reduces the development difficulty of the color resist layer 14 and improves the aperture ratio of the product, and can be implemented on a small-sized product having high resolution such as 8K and 16K. Moreover, in the process of the planarization layer 15, after the photomask and the substrate 11 are aligned, the subsequent color resist layer 14 does not need to be aligned again, which saves a process step and avoids the deviation of the again alignment.

Due to the alignment of the opening during formation of the color resist layer 14 can be avoided, there is no deviation when forming the opening in the color resist layer 14, so that the width of the opening formed in the color resist layer 14 can be reduced, thereby reducing the width of the source/drain metal layer 124 of the transparent conductive layer 17 for the electrical connection and further increases the aperture ratio.

In summary, the first opening 161 and the second opening 162 are aligned with the substrate by a photomask and the process for forming the opening structure is then completed.

In some embodiments, the opening structure can also be formed at a time using a dry etch process. That is, after the planarization layer is completed, an opening is shaped and formed in the open region of the planarization layer by a dry etching process to form an opening structure.

Then, the process proceeds to step S7.

Step S7: A transparent conductive layer 17 is formed on the planarization layer 15. The transparent conductive layer 17 covers the opening structure 16 and is electrically connected to the source/drain metal layer 124. The transparent conductive layer 17 may be indium tin oxide.

Thus, the method for forming the color filter array substrate 100 of the embodiment of the present application is completed.

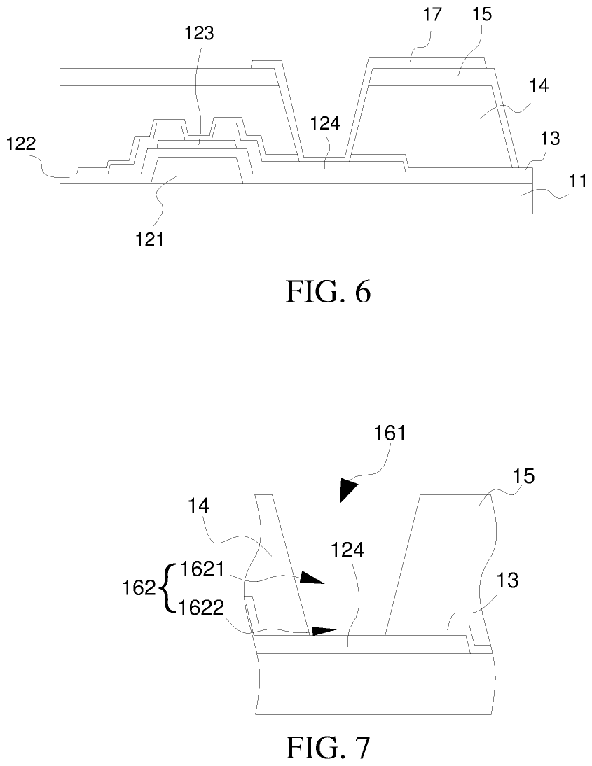

Please refer to FIG. 6, FIG. 6 is a schematic structural diagram of a color filter array substrate according to an embodiment of the present application. The present application also relates to a color film array substrate 100 comprising a substrate 11, a thin film transistor array structural layer 12, a passivation layer 13, a color resist layer 14, a planarization layer 15, an opening structure 16, and a transparent conductive layer 17.

Specifically, the thin film transistor array structural layer 12 is disposed over the substrate 11. The thin film transistor array structural layer 12 comprises a gate metal layer 121, a gate insulating layer 122, an active layer 123, an ohmic contact layer (not shown), and a source/drain metal layer 124. The passivation layer 13 is disposed over the thin film transistor array structural layer 12. The color resist layer 14 is disposed over the passivation layer 13. The planarization layer 15 is disposed over the color resist layer 14. The opening structure 16 penetrates through the planarization layer 15, the color resist layer 14, and the passivation layer 13 to expose the source/drain metal layer 124. A transparent conductive layer 17 is disposed over the planarization layer 15 and covers the opening structure 16. The transparent conductive layer 17 is electrically connected to the source/drain metal layer 124.

It should be noted that the opening is not formed in the color resist layer 14 of the present application in advance, and the planarization layer 15 is directly formed on the color resist layer 14 after the color resist layer 14 is formed. The opening structure 16 of the color filter array substrate 100 of the present application is formed in the opening area of the planarization layer 15, and then an opening is formed in the color resist layer 14 and the passivation layer 13 by a dry etching process. Compared with the conventional technology, this arrangement firstly avoids the requirement of forming an opening in the color resist layer and reduces the difficulty for developing the color resist layer, and secondly avoids alignment between the mask and substrate identification mark during the color resist layer process to prevent deviation caused by insufficient precision, and thirdly increases the aperture ratio of the product.

In addition, in the conventional technology, since an opening is first formed in the color resist layer, and then the planarization layer fills the opening of the color resist layer, so that a thickness of the planarization film at the opening is thicker than other regions and more light is required for decomposition. Therefore, during the forming process, more exposure time is required in the case of a fixed exposure, and the tact time of production is increased, thereby limiting the increase in productivity.

The method for forming the color filter array substrate of the embodiment of the present application does not form an opening during the process of the color resist layer, and the opening is formed after formation of the planarization layer to penetrate the planarization layer, the color resist layer, and the passivation layer and forms an opening structure. Since the color resist layer is not formed with an opening, the thickness of the planarization layer of the original opening area is not thicker than other areas, so that the exposure time performed to the planarization layer can be reduced, thereby increasing production capacity and reducing the production cost of the product.

Specifically, please refer to FIG. 7. FIG. 7 is a schematic structural diagram of an opening structure of a color filter array substrate according to an embodiment of the present application. In the color filter array substrate 100 of the present embodiment, the first opening 161 is formed in the planarization layer 15. A second opening 162 is defined in the color resist layer 14 and the passivation layer 13. The first opening 161 and the second opening 162 form an opening structure 16.

The second opening 162 comprises an upper portion 1621 and a lower portion 1622. The wall of the opening of the upper portion 1621 is formed by the color resist layer 14. The wall of the lower portion 1622 is formed by the passivation layer 13. The wall of the first opening 161 is formed by the flat layer 15.

The passivation layer 13 is an inorganic material layer such as SiNx. The passivation layer 13 is deposited on the thin film transistor array structural layer 12 and covers the entire substrate 11 by chemical vapor deposition. The protective layer 13 may be a multilayer structure formed by alternately laminating two different inorganic materials.

In addition, the first opening 161 is formed by a photolithography process. The second opening 162 is formed by dry etching. The first opening 161 and the second opening 162 are aligned with the substrate 11 by a photomask to complete the processing of the opening structure.

The process for forming the color filter array substrate of the embodiment of the present application is similar to or the same as the method for forming the color filter array substrate of previously embodiment of the present application. For details, refer to the specific content of the method for forming the color filter array substrate of the previous embodiment of the present application.

Compared with the method for forming the color film array substrate and the color film array substrate of the conventional technology, the method for forming the color film array substrate of the present application and the process for forming the color film array substrate in the color resist layer does not form an opening during the process of the color resist layer, and the opening is formed after formation of the planarization layer to penetrate the planarization layer, the color resist layer, and the passivation layer and forms an opening structure. This arrangement firstly avoids the requirement of forming an opening in the color resist layer and reduces the difficulty for developing the color resist layer, and secondly avoids alignment between the mask and substrate identification mark during the color resist layer process to prevent deviation caused by insufficient precision, and thirdly increases the aperture ratio of the product.

While the present disclosure has been described with the aforementioned preferred embodiments, it is preferable that the above embodiments should not be construed as limiting of the present disclosure. Anyone having ordinary skill in the art can make a variety of modifications and variations without departing from the spirit and scope of the present disclosure as defined by the following claims.

What is claimed is:

1. A method for fabricating a color filter array substrate, comprising the following steps:
providing a substrate;
forming a thin-film-transistor (TFT) structural layer over the substrate, wherein the TFT structural layer comprises a source/drain metal layer;
forming a passivation layer over the TFT structural layer;
forming a color resist layer over the passivation layer;
forming a planarization layer over the color resist layer;
forming an opening structure over the planarization layer, the color resist layer, and the passivation layer, wherein the opening structure simultaneously penetrates the planarization layer, the color resist layer, and the passivation layer, and exposes the source/drain metal layer;
forming a transparent conductive layer over the planarization layer, wherein the transparent conductive layer covers the opening structure and electrically connects the source/drain metal layer;
wherein forming the opening structure over the planarization layer, the color resist layer, and the passivation layer comprising the following steps:
forming a first opening in the planarization layer;
forming a second opening in the color resist layer and the passivation layer at an area corresponding to the first opening, wherein the second opening penetrates the color resist layer and the passivation layer to expose the source/drain metal layer, and the first opening and the second opening form the opening structure; and
the passivation layer is an inorganic material layer.

2. The method for fabricating a color filter array substrate of claim 1, wherein the first opening is formed by a photolithography process, and the second opening is formed by a dry etching process.

3. The method for fabricating a color filter array substrate of claim 2, wherein the first opening and the second opening are formed by the same photomask.

4. The method for fabricating a color filter array substrate of claim 1, wherein the opening hole structure is formed by a dry etching process in one time during the step of forming the opening structure over the planarization layer, the color resist layer, and the passivation layer.

5. The method for fabricating a color filter array substrate of claim 1, wherein forming the thin-film-transistor (TFT) structural layer over the substrate comprising the following steps:
forming a gate metal layer over the substrate;
forming a gate insulating layer over the gate metal layer;
forming an active layer over the gate insulating layer;
forming an ohmic contact layer over the active layer; and
forming the source/drain metal layer over the ohmic contact layer.

6. A method for fabricating a color filter array substrate, comprising the following steps:
providing a substrate;
forming a thin-film-transistor (TFT) structural layer over the substrate, wherein the TFT structural layer comprises a source/drain metal layer;
forming a passivation layer over the TFT structural layer;
forming a color resist layer over the passivation layer;
forming a planarization layer over the color resist layer;
forming an opening structure over the planarization layer, the color resist layer, and the passivation layer, wherein the opening structure simultaneously penetrates the planarization layer, the color resist layer, and the passivation layer, and exposes the source/drain metal layer;
forming a transparent conductive layer over the planarization layer, wherein the transparent conductive layer covers the opening structure and electrically connects the source/drain metal layer.

7. The method for fabricating a color filter array substrate of claim 6, wherein forming the opening structure over the planarization layer, the color resist layer, and the passivation layer comprising the following steps:
forming a first opening in the planarization layer; and
forming a second opening in the color resist layer and the passivation layer at an area corresponding to the first opening, wherein the second opening penetrates the color resist layer and the passivation layer to expose the source/drain metal layer, and the first opening and the second opening form the opening structure.

8. The method for fabricating a color filter array substrate of claim 7, wherein the first opening is formed by a photolithography process, and the second opening is formed by a dry etching process.

9. The method for fabricating a color filter array substrate of claim 8 wherein the first opening and the second opening are formed by the same photomask.

10. The method for fabricating a color filter array substrate of claim 6, wherein the opening hole structure is formed by a dry etching process in one time during the step of forming the opening structure over the planarization layer, the color resist layer, and the passivation layer.

11. The method for fabricating a color filter array substrate of claim 6, wherein the passivation layer is an inorganic material layer.

12. The method for fabricating a color filter array substrate of claim 6, wherein forming the thin-film-transistor (TFT) structural layer over the substrate comprising the following steps:
forming a gate metal layer over the substrate;
forming a gate insulating layer over the gate metal layer;
forming an active layer over the gate insulating layer;
forming an ohmic contact layer over the active layer; and
forming the source/drain metal layer over the ohmic contact layer.

13. A color filter array substrate, comprising:
a substrate;
a thin-film-transistor (TFT) structural layer disposed over the substrate, wherein the TFT structural layer comprises a source/drain metal layer;
a passivation layer disposed over the TFT structural layer;
a color resist layer disposed over the passivation layer;
a planarization layer disposed over the color resist layer;
an opening structure disposed over the planarization layer, the color resist layer, and the passivation layer, and exposes the source/drain metal layer; and
a transparent conductive layer disposed over the planarization layer, wherein the transparent conductive layer covers the opening structure and electrically connects the source/drain metal layer.

14. The color filter array substrate of claim 13, wherein a first opening is disposed over the planarization layer, and a second opening is disposed over the color resist layer and the passivation layer, and the first opening and the second opening form the opening structure; and
the second opening comprises an upper portion and a lower portion, a sidewall of the upper portion is formed by the color resist layer, and a sidewall of the lower portion is formed by the passivation layer, wherein a sidewall of the first opening is formed by the planarization layer.

15. The color filter array substrate of claim 14, wherein the first opening is formed by a photolithography process, and the second opening is formed by a dry etching process.

16. The color filter array substrate of claim 13, wherein the passivation layer is an inorganic material layer.

17. The color filter array substrate of claim 13, wherein the TFT structural structure further comprises a gate meal layer, a gate insulating layer, an active layer, an ohmic contact layer, and the source/drain metal layer.
